(19) United States
(12) Patent Application Publication
(10) Pub. No.: US 2006/0181600 A1
(43) Pub. Date: Aug. 17, 2006

(54) Patterns formed by transfer of conductive particles

(75) Inventors: Robert P. Bourdelais, Pittsford, NY (US); Cheryl J. Brickey, Webster, NY (US)

Correspondence Address: Paul A. Leipold;Patent Legal Staff, Eastman Kodak Company, 343 State Street, Rochester, NY, 14650-2201, US

(73) Assignee: Eastman Kodak Company

(21) Appl. No.: 11/058,064

(22) Filed: Feb. 15, 2005

(51) Int. Cl. B41J 2/395

(52) U.S. Cl. 347/199

(57) ABSTRACT

The invention relates to a transfer element comprising a base having thereon a transfer layer of inorganic conductive particles in a polymer matrix wherein said transfer layer of inorganic conductive particles has an adhesion to said base of between 20 and 400 grams/cm.

### FIELD OF THE INVENTION

The present invention relates to thermal transfer printing of electrically conductive patterns on a receiving substrate by heating extremely precise areas of a print ribbon with thin film resistors. This heating of the localized area causes transfer of electrically conductive materials from the ribbon to the receiving substrate.

### BACKGROUND OF THE INVENTION

Thermal transfer printing has displaced impact printing in many applications due to advantages such as the relatively low noise levels, which are attained during the printing operation. Thermal transfer printing is widely used in special applications such as in the printing of machine-readable bar codes and magnetic alphanumeric characters. The thermal transfer process provides great flexibility in generating images and allows for broad variations in style, size and color of the printed image. Further, thermal transfer printing is capable of printing variable data, not requiring additional printing screens or cylinders to-be configured. Representative documentation in the area of thermal transfer formulations and thermal transfer media used in thermal transfer printing includes the following patents.

U.S. Pat. No. 4,687,701, issued to K. Knirsch et al. on Aug. 18, 1987, discloses a heat sensitive inked element using a blend of thermoplastic resins and waxes. U.S. Pat. No.4,698,268, issued to S. Ueyama on Oct. 6, 1987, discloses a heat resistant substrate and a heat-sensitive transferring ink layer. An overcoat layer may be formed on the ink layer.

U.S. Pat. No. 6,270,944 (Wolk et al) discloses and thermal transfer element for the formation of multilayered devices. The disclosed multilayers are utilized for wave guiding of light, providing semi-conducting charge carrier layer and a light producing layer. Anode and cathode layers disclosed include continuous layers of aluminum or gold.

WO 03/074601 A2 discloses the thermal printing of conductive polymers useful in printing conductive electrical devices, particularly thin film transistors known as sources and drains. The preferred conductive polymer utilized is polyaniline (PANI).

U.S. Pat. No. 5,932,643 discloses a thermal transfer ribbon containing conductive polymers utilizing wax, a polymer resin and a conducting polymer. Disclosed conductive polymers include polypyrolle, polyacetylene, polyazene, polyaniline, polyphenylene, polythiophene, poly-N-vinylcarbazole, polyvinylpyridine and polyindole.

A common feature in these thermal transfer media is the use of a substrate for the ink to be transferred. Polyethylene terephthalate (PET) films are preferred substrates in that the property profile for PET (heat resistance, tensile strength, etc.) is well suited for use in conventional thermal transfer printers. One characteristic of most polymeric films, including PET films, is the generation of static electricity when rolls of these films are unwound. It has been discovered that static electricity from the thermal transfer ribbon can be a source of premature print head wear through static-electrostatic discharge. Therefore, reducing the static level of thermal transfer ribbons is desirable. Adding conductive fillers to non-conductive polymeric materials is known to reduce the static levels of such materials. However, adding such conductive fillers to polyethylene terephthalate is not always possible, particularly where obtained from another source and, furthermore, adding such conductive fillers may detract from the desirable properties of PET film.

The use of separate anti-static layers on films for photographic materials has been disclosed in U.S. Pat. No. 4,916,011. Similar configurations have also been disclosed in U.S. Pat. Nos. 5,079,130 and 5,098,822. These anti-static layers comprise conductive polymers which show a high bonding strength to the substrate. Such a configuration is not advantageous in preparing thermal i transfer ribbons in that it requires another coating procedure and may also detract from the desired properties of polyethylene terephthalate during the thermal transfer process. Depending on the position of the anti-static layer (top or bottom), it may either interfere with separation of the ink from the substrate during transfer or affect print head wear.

Employing conductive pigments in the thermal transfer layer of the thermal transfer medium has been found to reduce static levels. However, such conductive fillers may add color to the thermal transfer layer. Conductive polymers, i.e., inherently dissipative polymers which do not require conductive fillers, have been found to be suitable replacements for polymers with electro-conductive fillers (powdered carbon, powdered nickel, metal particles and the like) for cathodes of electrolytic cells, where the primary function is conductivity.

### PROBLEM TO BE SOLVED BY THE INVENTION

There is a need for a thermal transfer element capable of providing thin, precise conductive patterns with an electrical conductivity of less than 10 ohms/cm. Further, there is a need to provide a method of printing the precise conductive patterns in a roll format.

### SUMMARY OF THE INVENTION

It is an object of the invention to provide thin, precise conductive patterns.

It is another object to provide conductive patterns having a conductivity less than 10 ohms/cm.

It is a further object to provide a transfer element capable of providing conductive patterns.

These and other objects of the invention are accomplished by a transfer element comprising a base having thereon a transfer layer of inorganic conductive particles in a polymer matrix wherein said transfer layer of inorganic conductive particles has an adhesion to said base of between 20 and 400 grams/cm.

### ADVANTAGEOUS EFFECT OF THE INVENTION

The invention provides a transfer element capable of printing thin, precise electrically conductive patterns for applications such as electrical circuits and membrane switches. Further, the invention includes a printing method capable of efficiently printing high precision, thin conductive lines from digital design files.

### DETAILED DESCRIPTION OF THE INVENTION

The invention has numerous advantages over prior practices in the art. Prior art conductive patterns are printed utilizing ink systems containing metallic silver, a polymer binder and hardener materials. Prior art printing methods include flexo-graphic printing or silk screening. The invention provides a conductive transfer element that is printed utilizing a digital thermal transfer printer allowing designs for circuits or membrane switches to be quickly and efficiently printed for design validation. Prior art printing techniques typically require several days to weeks before the necessary tooling can be fabricated for the printing of the design. Because the invention provides quick and efficient means to produce flexible circuits or membrane switches, the invention is ideal for building prototypes for assembly into larger systems such as consumer appliances, display screens and testing equipment without the need for intermediate tooling for each contemplated design.

The invention materials allow for high precision conductive lines to be printed onto a variety of substrate materials including polymer substrates. The resolution of the printed conductive is advantaged to prior art methods of printing and allows a reduction in the width of the printed conductive lines. A reduction in line width and an increase in printing precision allow for high precision, small conductive patterns resulting in smaller, more efficient electrical devices.

Prior art conductive inks typically require a post curing process to dry solvents from the ink, improve the bond between the conductive inks and improve conductivity of the conductive inks. The invention materials use heat energy to transfer a polymer matrix containing conductive materials onto the desired substrate. The transfer heat energy also simultaneously adheres the conductive lines to the desired substrate and fuses the inorganic conductive materials contained within the polymer matrix to increase the conductivity of the conductive pattern avoiding the prior art practice of curing inks.

In addition to the desirable electrical properties of the invention, the materials utilized in the invention are generally reflective to visible light energy. By providing a transparent or opaque substrate containing an optically reflective pattern, the printed substrates can be utilized to modify or enhance visible light reflection or transmission and thus can be used in applications such as LCD displays, OLED displays, and LED displays. Because the reflective pattern can be printed, the opportunity for customization of optical substrates is possible allowing for example, automobile displays to be customized to customer preference. These and other advantages will be apparent from the detailed description below.

Materials in general can be divided into three major categories, conductors, semiconductors and insulators, according to their behavior under electrical current. Electrical conductors are typically metallic solids that have low electrical resistivity, ranging approximately 1.6×10⁻⁸ to 1.4×10⁻⁶ ohm.meter, whereas insulators have high resistivity, ranging from about 10⁷ to 10¹⁸ ohms.meter at room temperature. The electrical resistivity of semiconductors is intermediate between that of solid metals and insulators and ranges from 10⁻⁴ to 10⁶ ohm.meter at room temperature. The ability of a material to conduct an electrical current is termed electrical conductivity. The conduction of electrical current is the result of movement of electrons, ions or both through a lattice. Metallic solids are particularly good conductors of electrical current because of their mobility of some of the valance electrons. For the invention materials, resistivity expressed in terms of ohm.cm or ohm.meter is measured utilizing an electrical multi-meter capable of measuring resistance, current and voltage to the second decimal place. Resistance per unit length is an important measure of resistivity when measuring conductive patterns. It is understood that the amount of current that can be carried by a conductive line is a function of the volume of the conductive line. All measurements of resistivity for a printed conductive line assume that the conductive line has a thickness of approximately 5 micrometers and a width of approximately 1 mm, which is a typical line thickness and width for prior art flexible screen printed materials. It is understood that by significantly increasing the thickness of a conductive printed line, or by increasing the width of the printed line, that the resistivity of a printed line can be reduced, however, increasing line thickness or width increases cost and decreases flexibility of the conductive patterned substrate.

Adhesion of the conductive particles to a substrate is an important factor in determining the quality and utility of the invention. Adhesion of the conductive particles depends upon such factors as surface energy, transfer energy, polymer Tg, polymer composition, surface roughness and covalent bonding. Adhesion is measured utilizing a tape test in which pressure sensitive tape is adhered to the conductive particles contained in the transfer element, the electrically patterned element or the diffusely reflective patterned element. The pressure sensitive tape is selected so that, upon separation from the conductive pattern, substantial amount conductive particles are present on the surface of the pressure sensitive adhesive. The tape is then pulled away from the adhesion surface at 180 degrees at a specified rate and the force required to pull the tape away is measured through a device such as in INSTRON gauge. Upon pulling the tape away from the desired surface, the pressure sensitive adhesive typically will contain the conductive particles. If no conductive particles are present, a more aggressive tape must be utilized because the intent of the test is to measure the adhesion force between the conductive particles and the substrate.

In order to accomplish a transfer element capable of printing high precision, conductive patterns, a transfer element comprising a base having thereon a transfer layer of inorganic conductive particles in an insulating polymer matrix wherein said transfer layer of inorganic conductive particles has an adhesion to said base of between 20 and 400 grams/cm is preferred. Inorganic particles have been shown to provide excellent electrical conductivity compared to prior art conductive organic materials such as polypyrolle, which typically provides electrical conductivity around 200 ohms/cm. Inorganic materials such as copper, silver and gold are capable of providing conductivity less than 1 ohm/cm. The transfer element preferably has an adhesion to the base of between 20 and 400 grams/cm. Adhesion less than 15 grams/cm is not sufficient adhesion between the insulating polymer and the base resulting in de-lamination during manufacturing. Adhesion greater than 450 grams/cm is difficult to transfer utilizing heat energy and results in a lack of pattern uniformity. More preferably, the adhesion to the base is between 20 and 100 grams/cm.

It has been found that inorganic conducting materials that have a large surface area or have a high aspect ratio are generally preferred. Both inorganic whiskers and inorganic flakes have been found to be both efficiently printed and have a sufficiently high conductivity. In a preferred embodiment of the invention, the conductive particles comprise whisker shaped particles. Conductive whiskers have a length dimension that is significantly larger than the cross sectional dimensions of the whisker. Suitable whiskers can have a length dimension that is 100 to 10,000 times larger than the cross sectional dimensions of the whisker. Whiskers are also preferred because they have been shown to orient in the direction of flow during coating of whiskers onto the base. Oriented whiskers have been shown to improve conductivity in the oriented direction as much as 17% compared to randomly oriented whiskers. Additionally, the conductivity of thermally transferred whickers is improved over spherical particle type conductive elements as the number of current bridges is reduced by 10 to 10,000% compared to spherical particle type conductive elements.

In a preferred embodiment of the invention, the inorganic conductive particles have an aspect ratio of at least 1000:1. Conductive particles having an aspect ratio greater than 1000:1 have been shown to provide excellent path for electrical signals. In particular, inorganic materials with an aspect ratio greater than 1000:1, oriented in the direction of electrical pattern have been shown to result in higher levels of conductivity compared to random orientation of the high aspect ratio conductive inorganic particles. Orientation of the high aspect ratio inorganic materials is preferably accomplished by flow field orientation encountered during coating operations were the particles are subjected to shearing forces. Alternatively, orientation of the high aspect ratio inorganic particles preferably occurs from a post coating orientation of both the printed conductive pattern and the substrate on which the conductive pattern is printed. It has been found that at least a 25% orientation of a substrate containing a printed conductive pattern provides the desired degree of high aspect ratio conductive particles orientation to achieve an acceptable conductivity. Because the high aspect ratio particles are typically coated in a polymer matrix, heated orientation above both the substrate and polymer matrix Tg allows for efficient orientation of the high aspect ratio conductive particles compared to stretching a 20 degrees C.

In another embodiment of the invention, the inorganic conductive particles comprise platelets or flakes. Platelets or flakes have a large surface area compared to spherical conductive materials and therefore more efficiently conduct current compared to spherical conductive particles. Platelets have a smaller thickness profile compared to spherical conductive particles and are better suited for thermal transfer and result in thermally transferred elements that have a low profile which yields thin conductive elements. Platelets have a diameter that is many times larger than the thickness of the platelet and can be compared to a diner plate or pancake. Preferred size of platelets is between 1 and 12 micrometers in diameter. Sizes less than 0.5 micrometers are difficult to manufacture by the prior art mechanical method of manufacturing platelets and result in high solution viscosity due to a large amount of exposed surface area. Sizes greater than 15 micrometers generally result in higher resistivity than particles sized around 6 micrometers.

In another embodiment of the invention, the inorganic conductive particles comprise metallic flake having a thickness between 0.2 and 2 micrometers. Metallic flakes are preferred because they have a large surface area compared to their total volume. Large surface area particles have been shown to provide excellent conduction of electrical current after the flake particles have been fused during heated transfer. Particles having a thickness greater than 3 micrometers may be difficult to coat in a thin layer and have a lower surface area to volume ratio. Conductive particles less than 0.10 micrometers, while effective conductors of electricity, are expensive and tend to agglomerate during dispersion of the particles into a polymer matrix compared with thicker particles.

Metals particles are preferred because they are typically excellent conductors of electrons. Further, metallic particles can be made small by methods known in the art, are easily dispersed in polymer matrix materials and can be inexpensive compared with prior art organic conducting materials. Also, some metallic particles have also been shown to sinter or anneal during heated transfer of the transfer element of the invention, further improving conductivity. Preferred inorganic conductive particles comprise a metal selected from at least one member of the group consisting of copper, aluminum, gold, iron, and platinum. More preferably the inorganic particle of the invention comprises silver. Silver is an excellent conductor of electrons can be formed into particles with at least one dimension less than 100 nanometers and is an excellent conductor of heat energy, providing excellent sintering during heated transfer. Further, silver has been shown to have a lower oxidation rate than commonly available aluminum flake materials and thus will tend to yield conductive members that have longer lifetimes.

In a preferred embodiment of the invention, the inorganic conductive particles have at least one dimension less than 100 nanometers. Conductive particles that have at least one dimension less than 100 nanometers have been shown to provide excellent conductivity compared to larger particles because of the increase in surface area compared to the volume of the particle. Further, because 100 nanometers is less than the wavelength of visible light, the inorganic conductive materials will be transparent to visible light in thin films, thus allowing the printed conductive pattern to both efficiently transmit visible light energy and have a high conductivity. For example, prior art EMI shielding typically comprises a printed electrically conductive pattern or metal wire structure, both of which are not transparent to visible light energy. By providing small conductive particles, less than the visible wavelength of light, a printed EMI shield can be constructed on a polymer substrate that is both a EMI shield and transparent to visible light. A transparent EMI shield would have commercial value in displays such as LCD or OLED displays were an EMI shield could be utilized in the optical components.

The transfer element preferably has a resistivity of greater than 100 ohms/cm. Since the inorganic conductive particles in a polymer matrix have some degree of separation because of surrounding polymer matrix, the resistivity of the transfer element is greater than resistivity of the conductive particles. Upon thermal transfer of the inorganic particles in the polymer matrix, the conductive particles are fused and therefore exhibit a lower, more desirable resistivity. The resistivity of the transferred conductive material largely depends upon the concentration of the inorganic particles, the degree of dispersion of the organic particles and the resistivity of the matrix polymer.

In an embodiment of the invention, the average spacing between the inorganic conductive particles is between 20 and 600 nm. Average spacing less than 10 nanometers is difficult to achieve and tends to increase the viscosity of the particle/polymer matrix making manufacturing of the transfer element be known methods in the art difficult. An average spacing greater than 1000 nanometers begins to reduce the statistical probability of fusing a sufficient quantity of the inorganic particles in the polymer matrix thereby increasing resistivity of the thermally transferred element.

In an embodiment of the invention, the matrix polymer preferably has a Tg of between 30 and 80 degrees centigrade. The Tg of the matrix polymer is related to the amount of fusing of the conductive particles. It has been shown that the transfer temperature should be at or greater than the Tg of the polymer matrix. Since commonly available resistive thermal heads utilized for thermal dye transfer printing typically have an temperature operating range between 30 and 80 degrees centigrade, for simultaneous transfer and fusing of the conductive particles, the Tg of the polymer matrix should be within the operating range of thermal printing heads.

In a further embodiment of the invention, the transfer element has a matrix comprising polyurethane. Polyurethane polymer matrix has been shown to be an acceptable matrix for the dispersion of inorganic conductive particles. Further, polyurethane polymer is flexible allowing for the transferred element to remain flexible for flexible conductive products such as membrane switches or liquid crystal cells on transparent polycarbonate back plane. In addition, polyurethane allows fusing of the inorganic conductive particles by flowing at thermal transfer temperatures between 60 and 200 degrees centigrade or during subsequent fusing steps during the preparation of an electrically patterned element.

In preferred embodiment of the invention, the polymer matrix preferably comprises a conductive polymer. It has been shown that the use of conductive polymers reduce the heat and or pressure required to fuse the inorganic conducive particles in order to obtain the desired conductivity. Polymers typically are insulating materials that have a very high resistivity. By providing a polymer matrix material that is conducting, the dependence on fusing or sintering of the conductive particles is reduced. Examples of preferred conductive polymers for use as a matrix polymer include polypyrolle, polyacetylene, polyazene, polyaniline, polyphenylene, polythiophene, poly-N-vinylcarbazole, polyvinylpyridine and polyindole. These polymers typically have a resistivity of around 200 to 600 ohms/cm per 5 micrometers of thickness.

In another preferred embodiment of the invention, the transfer layer comprises colorants. Colorants are useful because they allow for easy visual assessment of the transferred element. Further the colored layer can be used to differentiate multiple utilities in patterned conductive element. For example, input conductive patterns can be colored red and output conductive patterns can be colored blue. Colorants are preferable incorporated into the polymer matrix and may comprise dye, pigments or mixtures thereof. Additionally, temperature sensitive dyes can be used to both color the transferred conductive pattern and by change of color or color density can be used to signify successful fusing or sintering of the inorganic conductive particles.

The base upon which the transfer layer is applied preferably has a surface energy between 28 and 36 dynes/cm on the side adjacent to the transfer layer. By providing a relative low surface energy on the side adjacent to the transfer layer, the thermal transfer efficiency is improved compared to high surface energy bases. Surface energy between 28 and 36 dynes/cm are accomplished by providing a smooth surface or providing a thin layer of low surface energy polymer surface as PTFE or providing a base that contains a slip materials such as a wax.

In another preferred embodiment of the invention, the transfer element further comprises a thermally activated release layer on the base. Thermally activated release layers are typically polymer layers having a Tg less than the transfer temperature. Upon thermal transfer, the thermally activated release layer flows, breaking the bond between the transfer layer and the base. It has been shown that when a thermally activated release layer is utilized, the Tg of the thermally activated layer should be less than the Tg of the transfer layer polymer matrix. This allows for high transfer efficiency and while maintaining the mechanical integrity of the transfer layer.

In another preferred embodiment of the invention, the transfer element can have two or more layers that differ in conductivity or composition. Two or more layers that vary in conductivity allow for patterned conductive elements having a conductivity gradient in the direction perpendicular to the base of the transfer element. This is particularly useful for EMI shielding applications or for the construction of redundant conductive patterns. The two or more layers may differ in composition, for example, allowing for different conductive particles, different polymer matrix materials or a polymer adhesion promotion layer having a Tg lower than the polymer matrix.

In order to improve the dispersion of the inorganic conductive particles in the polymer matrix, the use of a surfactant in the transfer layer is preferred. During fabrication of the transfer element, the transfer layer is applied to the surface of the polymer base. The dispersion of the conductive particles is important for transfer layer uniformity and resulting conductivity uniformity. The use of surfactants know in the art for use in micro-metallic particles are preferred and are used to ensure an acceptable dispersion of the conductive particles. Further, surfactants such as waxes may be used to coat the surface of the conductive particles prior to dispersion.

An example of a two layer transfer element capable of being thermal resistive head pattern-wise printed to a receiver layer coated substrate is as follows:

Ag platelet having 1.12 micrometer diameter and thickness of 0.41
micrometers contained in a polyurethane matrix having a Tg of
59 degrees C.
6 micrometer thick polyester base

Electrically patterned elements on flexible substrates have a variety of uses. Electrically patterned elements on flexible substrates can be used for membrane switches, radio frequency labels, EMI shielding, flexible circuits, electrical connections, flexible photovoltaic cells and liquid crystal TFT arrays. Prior art flexible electrically patterned elements are accomplished by the printing of conductive inks by use of screen-printing, gravure printing or ink jet printing. The use of thermal transfer allows for the fusing or sintering of the conductive particles to increase conductivity and allows for adhesion of the conductive layer to a receiving layer to increase the mechanical durability of the conductive pattern, especially in flexible applications where the conductive pattern can be subjected to tensile and compressive forces.

An electrically patterned element comprising a flexible substrate and a receiving layer wherein said receiving layer is provided with a conductive pattern having a resistivity of less than 10 ohms/cm, and wherein said conductive pattern comprises inorganic conductive particles in a matrix polymer is preferred. A pattern having a resistivity less than 10 ohms/cm allows the pattern to be used for a variety of electrical applications that require flow of electrical current or electrical signals without significant loss. The receiving layer provides an adhesion layer that increases the adhesion of the inorganic conductive particles in a polymer matrix that are transferred onto the receiving layer from the transfer element. This allows the conductive pattern to be suited applications requiring a flexible substrate such as membrane switches or flexible displays. In an preferred embodiment, the receiving layer is constructed of the same polymer as the matrix polymer allowing the heated thermal transfer of the conductive transfer layer to bond the matrix polymer with the receiving layer polymer. In another preferred embodiment of the invention, the receiving layer Tg is less than the matrix polymer Tg. It has been found that if the receiving layer Tg is less than the matrix polymer Tg that bond strength is improved and thermal transfer efficiency from a donor web is improved.

In order to achieve a resistivity less than 10 ohms/cm, a sufficient amount of the conductive particles must be in contact to avoid being surrounded by the electrically insulating matrix polymer, which decreases the conductivity of the conductive pattern. This has been accomplished in the art by having a high weight ratio of conductive particles to matrix material. The disadvantage for a high weight ratio is the high cost of the conductive particles, poor adhesion to flexible substrates and an inability to ink jet print conductive inks containing a high weight ratio because of ink jet head clogging. Preferably, a lower weight ratio of conductive particles to matrix material can be utilized to obtain a resistivity less than 10 ohms/cm if the inorganic conductive particles are sufficiently close. Preferably the particles are sufficiently close because of the fusing or sintering of the inorganic particles during heated thermal transfer or subsequent heat application. During heated thermal transfer, the dispersed inorganic conductive particles fuse together allowing for the flow of electrical current or electrical signals in fused path of conductive particles.

Electrical resistivity of the patterned line between 10 and 5 ohms/cm also has an advantage of generating heat energy. Since electrical resistivity is the tendency of a material to oppose the flow of electrical current, higher resistivity can result in heat generated. The amount of heat, specified in joules/sec can be determined by the equation P=i²R where P is the power, i is the current and R is the resistivity. Patterning a flexible substrate can result in differential heating of the substrate allowing for heated mirrors, changes in transmitted and reflection optical properties as a function of temperature or balancing undesirable flexible substrate temperature gradients as found in LCD display devices initiated at start-up of a LCD device until a LCD device reaches a steady state condition, for example. Further, since resistivity is a function of the cross sectional area of a conductive patterned line or area, the resistivity and thus the heat can preferably vary depending on the thickness of the conductive pattern, or the amount of material transferred to the flexible substrate. This allows, for example, for differential heating of the flexible substrate to occur depending on the dimension and geometry of the conductive pattern.

In another preferred embodiment, the receiving layer comprises a pattern of adhesive transfer sites. Adhesive transfer sites are areas of the receiving layer that contain an adhesive such as a pressure sensitive adhesive, hot melt adhesive or UV cure adhesive. The adhesive sites are utilized to facilitate pattern-wise transfer of the inorganic conductive particles to the receiving layer. The adhesive transfer sites, under transfer conditions, will have bond strength to the polymer matrix greater than adjacent areas without the adhesive transfer sites. A pattern of adhesive transfer sites can be applied to the surface flexible substrate by means know in the art such as gravure printing, ink jet printing, electro-photographic printing or patterned coating. The patterned adhesive transfer sites may, for example, include a pattern of an electric circuit, electric connector, membrane switch, LCD TFT back plane, or EMI shielding pattern. During thermal transfer of the inorganic conductive particles in a matrix, the inorganic particles in a matrix are transferred and adhered to the adhesive pattern applied to the flexible substrate. The patterned adhesive transfer sites, that is a receiving layer that is adhesively patterned, allows for a uniform heated transfer of the inorganic conductive particles in a polymer matrix as opposed to a patterned heated transfer sources such as a resistive thermal print head or a scanning laser.

For the protection of the electrically conductive patterned element the application of a protective layer is desired to protect the delicate pattern and reduce unwanted oxidation of the inorganic materials. A blanket polymer, situated adjacent the patterned conductive layer provides the desired protection to the electrical pattern. In a further embodiment of the invention, the electrically patterned element further comprises a blanket polymer. The blanket polymer can be applied to the electrically patterned element pattern-wise, in registration with the patterned conductive pattern or may be uniformly applied the entire electrically patterned surface. The blanket polymer preferably is electrically insulating, electrically insulating the conductive pattern from other components or destructive electrical grounds. Further, the blanket polymer preferably has low water and oxygen permeability, protecting the patterned element from destructive water and oxidizing oxygen, which has the undesirable effect of reducing the conductivity of some conductive particles such as aluminum. The blanket polymer preferably is hard and can withstand abrasion, thereby protecting the patterned element from wear, and flexure forces that could reduce electrically conductivity by creating a break or space in the conductive pattern. In another preferred embodiment, the blanket polymer preferably contains a colorant, so that the presence of the blanket polymer can be detected, which aids in the assembly and registration of the conductively patterned element of the invention. Desired colorants have high contrast to the substrate and have a density greater than 1.0 so that they can easily be seen by the naked eye.

The blanket polymer applied to the surface of the conductive element provides electrical and mechanical protection to the conductive pattern. Preferably, the blanket can also contain an additional conductive pattern on the surface of the blanket polymer. The additional layer allows for two conductive patterns to be applied on one base material allowing for miniaturization of electronic devices or for a redundant circuit to increase the reliability of electrical components. The blanket polymer preferably comprises a protection utility and also comprises the ability to adhere to the conductive pattern. The blanket polymer may comprise two or more layers, one layer to provide protection and one layer to provide adhesion surface to the subsequent conductive pattern.

If two or more stacked layers of conductive patterns are utilized, at least one conductive hole through the blanket polymer is preferred. At least one hole provides the means to electrically connect the two or more layers, allowing electrical current or signals to flow between the two layers. The connection of two or more stacked conductive layers allows for a significant decrease in space as the conductive patterned layers can be stacked. Holes can be created in the blanket polymer by transferring the blanket polymer image or pattern wise, leaving un-protected areas or holes. During the patterning of the second conductive layer, the hole can be printed with the conductive materials creating a connection between the two conductively patterned layers. Holes can be circular, rectangular, triangular, oval or any shape that meets the connectivity requirements. Further, the holes can cover as much as 50% of the area of the blanket polymer, more preferably less than 10% of the blanket polymer area.

Suitable blanket polymers comprise polymers that can be heat transferred from a donor web and provide electrically insulating properties. Preferred blanket polymers are selected from the list comprising polyurethane, polyester, acrylic, vinyl, polyamide and polyolefin.

Conductive patterns, consisting of lines and shapes, applied to the surface of a flexible substrate, can be utilized for a variety of flexible, conductive applications. By reducing the line width or the size of the conductive shape, the flexible pattern can be made smaller allowing for small and more efficient electrical devices. The conductive pattern preferably has a line width between 5 and 500 micrometers, more preferably, between 5 and 50 micrometers. For line widths between 25 and 500 micrometers, a resistive thermal head, which is a head that contains an array of micro-resistors, has been shown to efficiently transfer conductive materials in a pattern. For line widths between 5 and 50 micrometers, laser thermal transfer has been shown to efficiently transfer conductive materials in a pattern. Laser transfer is more capable of transferring thinner lines as the beam width of the laser is smaller than the practical size of a micro-resistor.

In order to generate high quality conductive lines, the electrically patterned element preferably has a line edge wiggle factor of less than 20% more preferably less than 10%. A conductive line edge wiggle factor is the amount of variation in the line width over a line segment. Large variations in line width can cause electrical or signal loss and require sufficient line spacing so that pattern lines do not cross talk or cause unintended connection. More specifically, line wiggle factor is defined as the arithmetic average absolute value of the width variation contained in the patterned conductive line measured over a 10 mm line segment sampled every 1 mm along the segment. Line edge wiggle factor can result from resistive head variations, conductive particle size, and transfer rate of the conductive layer to the flexible substrate and variation in surface chemistry of the receiving layer.

Patterned substrates containing reflective particles have utility in the field of optics. The conductive inorganic particles utilized in this invention for electrically conductive properties are also reflective to a portion of the electro-magnetic spectrum. The patterned element of the invention is also reflective to a portion of the electromagnetic spectrum. The ability to pattern a flexible substrate with both reflective and/or conductive materials has great value for changing or altering the properties of reflected electromagnetic energy or more specifically, visible light. The electromagnetic energy may be reflected energy and/or transmitted energy. Because the transfer mechanics utilized in this invention are related to the surface topology of the flexible substrate to be printed, it has been found that protuberances located on the surface of the flexible substrate allow for conductive and/or reflective materials to be transferred substantially to the peak or upper most portion of the protuberances while little or no materials are transferred to the valleys or lower most portions of the protuberances. By patterning a flexible substrate with polymer protuberances, the transfer element of the invention, which can be both electrically conductive and reflective to a portion of the electromagnetic spectrum, can be utilized to transfer reflective particles to the surface of protuberances located on the surface of a flexible substrate. Protuberances such as cylinders, cubes, rectangular array or prism array, when printed with the transfer element, contain reflective particles on the upper most surface of the protuberance allowing for discrete reflectivity in a pattern.

A diffusely reflective patterned element comprising a flexible substrate having at least one surface polymeric protuberances having an average height greater than 10 micrometers and a layer of diffusely reflective particles located on a top surface of said protuberances wherein a top surface with a diffuse reflectivity of at least 80% is preferred. Having an average protuberance height less than 5 micrometers does not adequately ensure that the diffusely reflective particles are located on the top surface of the protuberances in all transfer systems. The diffusely reflective patterned element has a diffuse reflectivity greater than 80% and can diff-usely reflect and or transmit light. The high level of diffluse reflectivity results from the random dispersion of particles in a polymer transfer matrix. A thermal printer requires very smooth media in which to print a uniform layer; if there are pits or low points in the media, dyes or polymer layers are not transferred to that pit (or non-protrusion areas). A thermal printer (using heat and/or pressure or lasers) can transfer the reflective material only to the ridges to make them reflective and leave the rest of the individual elements unprinted and therefore transparent. Binder, receiving, or adhesion layers may be added to ensure transfer of the reflective materials.

Protuberances located on the surface of a flexible substrate comprising surface microstructures are preferred. Protuberances on a flexible substrate have been shown to be an efficient way to pattern a flexible substrate such as polycarbonate. Microstructure protuberances can be tuned for different light shaping and spreading efficiencies and how much they spread light and are three-dimensional. Examples of microstructures are simple or complex lenses, prisms, pyramids, posts, and cubes. The shape, geometry, and size of the microstructures can be changed to accomplish the desired light shaping. The surface microstructure can comprise any surface structure, whether ordered or random. The microstructure can be a linear array of prisms with pointed, blunted, or rounded tops or sections of a sphere, prisms, pyramids, and cubes. The protuberances discrete or continuous and can be random or ordered, and independent or overlapping. The sides can be sloped, curved, or straight or any combination of the three. The protuberances can also be retroreflective structures, typically used for road and construction signs or a Fresnel lens, designed to collimate light. The protuberances can be individual optical elements varying in shape, size, location or frequency.

In a preferred embodiment of the invention, the protuberances have a height of between 10 and 1000 micrometers, more preferably between 10 and 100 micrometers. Protuberance heights greater than 1 100 micrometers are difficult to integrate into a flexible substrate, further these protuberances are difficult to wind into a roll and therefore are not economical. It has been shown that to modify the direction of light, as through surfaces lenses, lens heights or protuberance heights less than 100 micrometers typically can accomplish the desired objective.

Protuberances on the surface of a flexible substrate can be made using UV cast and cure polymers, embossing or extrusion roller molding. Tolerances for protuberances produced in this manor are typically smaller than prior art printing methods such as gravure coating or laser patterning. Sizes as small as post having a diameter of 5 micrometers have been successfully patterned with diffusely reflective particles contained in a transparent polymer matrix.

The diffusely reflective patterned element preferably contains particles selected from at least one member of the group consisting of Cu, Ag, Au, Al, Ni, TiO₂ and BaSO₄. The metallic components from the above list can provide both conductivity and diffuse reflectivity. The TiO₂ and BaSO₄ provide reflectivity. The percentage of diffuse reflectivity is related to the particle size, particle shape, thickness of the particle layer and the particle concentration. The reflective particles are preferably dispersed and transferred in a polymer matrix that adheres the particles to the protuberances and provides mechanical strength to the protuberances resisting flexure and abrasion forces that would decrease the quality and amount of diffuse reflectivity from the top surface of the protuberances.

The diffusely reflective particles located on the top of the protuberances preferably covers 1 to 50% of the surface area of the flexible substrate, more preferably between 2 and 10% of the surface. The amount of surface area is dependant on the application and the desired optical objective. For example, one might wish to reflectively diffuse transmitted light in a lens aperture that might only cover 2% of the surface. Conversely, one might want to diffuse reflective light from reflective posts covering 40% of the surface area.

An example of a patterned diffusely reflective element would be a transflector containing EMI (electromagnetic interference) shielding. Electronic devices operating normally in their intended environment, without conducting or radiating excessive amounts of electromagnetic energy, or being susceptible to such energy from internal or external sources, are in the state of electromagnetic compatibility, or EMC. Electromagnetic interference, EMI, is radiated or conducted energy that adversely affects circuit performance, and thus disrupts a device's EMC. Many types of electronic circuits radiate or are susceptible to EMI and must be shielded to ensure proper performance. Radiated EMI may be eliminated or reduced by the use of shielded enclosures and shielding materials. A flexible substrate containing a surface of 25 micrometer posts having on the surface thereon a layer of diffusely reflecting Al particles covering 40% of the surface area of the sheet. The diffusely reflective element of this example would transmit approximately 60% of incident perpendicular light and would diffusely reflect approximately 40% of the incident light allowing the element to be both reflective and transmissive. Further, the conductive Al particles would serve to provide an EMI shield. Such an element would have value for portable LCD devices such as cell phones, lap top computers and portable CD players.

Another example of a patterned diffusely reflective patterned element would be a linear array of 50 micrometer high prism structures that cover a substantial portion of a flexible substrate. The peaks of the prism sheet comprise a 90 degree included angle and have 1 micrometer flat ridge on the top surface. Prism elements are well known in the art for providing transmitted brightness gain on axis and are used to increase brightness on axis for display devices such as LCD devices. The ridge preferably has a reflectivity of between 80 and 95% at 500 nanometers. Because the ridge is flat, it does not shape light the same as the rest of the element, it is preferable to make it reflective such that the light that would have passed through the ridge would instead be reflected back, reflect diffusely off of the back reflector in a backlit display system and would strike the film again. This light that strikes the film has a good probability of passing through the film, not striking the ridge again and will therefore increase the amount of light that is shaped by the film and increase the on-axis brightness.

In order to form the patterned element, either on a substantially flat substrate or a substrate containing protuberances, the conductive pattern is preferably image-wise or pattern-wise transferred from the transfer layer to the receiving layer. A method of forming a patterned element comprising providing a transfer element comprising a base having thereon a transfer layer of inorganic conductive particles in an insulating polymer matrix wherein said transfer layer of inorganic conductive particles has an adhesion to said base of between 20 and 400 grams/cm, bringing said transfer element into transferring contact with a receiver element, wherein said receiver element comprises a flexible substrate and a receiver layer, transferring said transfer layer to said receiving element in a pattern is preferred. Adhesion of the conductive particles to the base of less than 15 grams/cm does not allow for efficient winding and transport of the transfer layer. Further, it has been found that adhesion of less than 15 grams/cm allows the conductive particles to flake off of the base, generating unwanted particulate in transfer devices and reducing the conductivity by reducing the amount of conducting particles in a pattern. When adhesion is above 425 grams it is difficult to accomplish transfer to the receiving layer as the particles and polymer are required to overcome the adhesion to the base before successful transfer can occur. Further, high adhesion to the base has been shown to result in patterned line wiggle exceeding 20%.

In order to accomplish the transfer of the conductive particles contained in the polymer matrix, heat mass transfer of the conductive element is preferred. The heat applied to the conductive transfer element serves to break the bond between the polymer matrix and the base. The heat also serves to increase the bond between the matrix polymer containing the conductive particles and the receiving layer. Preferably, the heat is applied to the conductive transfer element image-wise or pattern-wise by thermal resistive head or a laser. Both thermal resistive heads and lasers have been shown to provide sufficient heat to allow high quality transfer of the conductive transfer element to the receiving layer.

Thermal printing heads, which can be used to transfer from conductive donor elements to receiving elements of the invention, are available commercially. There can be employed, for example, a Fujitsu Thermal Head (FTP-040 MCS001), a TDK Thermal Head F415 HH7-1089, or a Rohm Thermal Head KE 2008-F3. Alternatively, other known sources of energy for thermal dye transfer may be used, such as lasers as described in, for example, GB No. 2,083,726A.

Additionally, heat may be applied to the transferred conductive pattern to further fuse or sinter the conductive particles, improving conductivity of the conductive pattern. The heat may be applied to the entire flexible substrate containing the conductive pattern by use of direct or indirect heating. It has been found that the use of a resistive thermal head or a pair of heated nip rollers improves the conductivity of conductive patterns. Alternatively, the heat may be applied to the conductive pattern image-wise or pattern-wise, applying heat and/or pressure to the conductive pattern.

In order for successful mass transfer of the conductive particles contained in the polymer matrix to occur, at the time of thermal transfer, the bond strength between the conductive particles contained in the matrix polymer should be greater than the bond strength between the conductive particles in the matrix polymer and the base. In a preferred embodiment the Tg of the matrix polymer is greater than the Tg of the receiving layer. With the Tg of the receiving layer being lower, the desired heat source can provide enough heat to increase the temperature of the receiving layer above the receiving layer Tg while staying below the Tg of the polymer matrix. The net result is transfer of the conductive layer containing the conductive particles to the substrate. It has been found that a Tg difference between the matrix polymer and the receiving polymer of at least 5 degrees C. provides the desired transfer while allowing for some variability in the heat source and unaccounted for heat sinks that may be present at the time of transfer.

In a preferred embodiment of the invention, the receiving layer preferably comprises a surface of a composition such as may be utilized in a hot melt adhesive. A hot melt adhesive is an adhesive that soften to viscosities suitable for coating at elevated temperatures (30 degrees C. to 200 degrees C.) and generally return to a flow-less state upon cooling. Preferred classes of hot melt adhesive are hot melt silicone adhesives containing plasticizer added in amount between 1 to 15 weight percent. The plasticizer addition decreases the dynamic viscosity of the adhesive allowing the hot melt adhesive to flow under elevated temperature and pressure thus increasing the bond strength between the patterned conductive element and the flexible substrate. Further the plasticizer addition has been shown to increase the elastic modulus of the adhesive, thereby improving the patterned conductive element resistance to flexure forces in flexible applications such as membrane switch or flexible display systems such as OLED or LCD. Preferred plasticizers include organic esters, organic waxes, polyphenylmethysiloxane, and alkylmethysiloxane waxes. The addition of a blanket polymer applied to the surface of the flexible substrate bearing the patterned conductive element renders the hot melt adhesive inactive as the any un-patterned bonding sites are covered with the blanket polymer.

The following examples illustrate the practice of this invention. They are not intended to be exhaustive of all possible variations of the invention. Parts and percentages are by weight unless otherwise indicated.

### EXAMPLES

### Example 1

In this example, a conductive pattern was generated on the surface of 125 micrometer thick transparent polycarbonate. The conductive pattern consisted on Ag flakes in a polymer binder. The conductive Ag flakes contained in the polymer binder was transferred to a polymer receiving layer on one surface of the polycarbonate substrate by the use of a thermal resistive print head. This example will demonstrate an electrically conductive pattern applied to the surface of a flexible polymer substrate.

Conductive Particle:

Commercially available flattened Ag flake trade name Silflake™ manufactured by Technic Inc. The silver flake had a 1.7 micrometer mean length with the thickness being less than 5 times the length dimension, a tap density of 2.2 g/cm³ and a specific surface area of 1.4 m²/gram. The Technic silver flake was coated with a wax to aid in dispersion.

Transfer Layer Base:

6 micrometer thick poly(ethylene terephthalate) donor coated with prior art slip chemistry known in the art to reduce friction between a resistive thermal print head and the donor element with the slip layer side opposite the conductive particle layer.

Conductive Particle Layer:

Matrix polymer for the conductive particle layer was an aqueous polyurethane dispersion having a Tg of 45 degrees C. Dispersed in the conductive binder was 85% (by weight of polyurethane) Ag flake and the resulting solution was 40% by weight solids. The conductive particle solution was kept in solution by shear mixing until it was coated on the transfer layer base by roll coating. The dry thickness of the conductive particle layer was 4.2 micrometers. Averaged over 10 samples, the adhesion of the conductive particle layer to the base was 31 grams/cm width and was tested on an Instron gauge using 90 degree peel at a rate of 1.0 cm/min.

Receiver Layer Coated Polycarbonate:

GE Lexan polycarbonate 125 micrometers thick having a 550 nm light transmission of 92%. Applied to one surface of the polycarbonate was aqueous dispersion of polyurethane having a Tg of 35 degrees C. and a dry thickness of 47.9 micrometers.

The construction of the transfer element was as follows:

Transfer layer base
Conductive particle layer

The construction of the receiver element was as follows:

Receiver layer
Transparent Polycarbonate Substrate

A Slit roll of the transfer element and a slit roll of the receiver layer coated polycarbonate were loaded in a Kodak ML500 Thermal Printer. The Kodak ML500 Thermal printer is a four head resistive head thermal printer capable of thermally transferring (in sequence) from four donor elements onto a moving receiver web. The first thermal print head transferred the conductive layer pattern-wise to the receiver layer coated polycarbonate at a head temp of 55 degrees C. The second thermal head was used to pattern-wise expose the transferred pattern to a 65 degrees C. The third and fourth head were not activated. The printing rate for the conductive element was 1.7 meters/min. The transferred pattern consisted of a series of machine direction lines varying in width between 100 micrometers and 1500 micrometers at 100 micrometer intervals. The line length was 30 cm and the spacing between all of the printed lines was 10 mm.

The construction of the electrically conductive patterned element was as follows:

Sintered patterned Ag flake in polyurethane matrix
Polyurethane receiver layer
Transparent polycarbonate substrate

The printed conductive lines were measured for electrical resistivity, line wiggle and adhesion to the flexible polycarbonate substrate. The resistivity was measured with an electrical multi-meter capable of measuring electrical resistivity to one hundredth of an ohm. The resistivity value of the 1.0 mm wide line was an average of 10 readings. Probe spacing between the readings was 1.0 cm. The line wiggle of each 1.0 mm line was measured with an optical microscope containing a measurement reticule with a resolving capability of 0.01 mm. The line wiggle was an average 10 readings with 1.0 mm spacing. Conductive line adhesion to the flexible polycarbonate substrate was measured with an Instron gauge using a 90 degree peel at a rate of 1.0 cm/min. The actual reading was mathematically scaled to a cm line width. The results of the above tests are contained in Table 1 below.

TABLE 1

| Test | Value |
|---|---|
| Resistivity | 5.7 ohms |
| Line wiggle | 3.1% |
| Adhesion | 67 grams/cm width |

As the data in Table 1 indicates, the conductive I mm wide line had an electrical resistivity less than 10 ohms per/cm, which allows the conductive line to be utilized for conductive traces for such electrical applications such as electrical connections, membrane switches and electrical circuits. The line wiggle was very low (3.1 %) and had line wiggle comparable to prior art conductive printing methods such as the screen-printing method of applying conductive inks to flexible substrates. The conductive line adhesion to the flexible polycarbonate was sufficient enough to allow for the conductive line to be utilized in flexible electrical applications such as flexible display. The significant reduction in resistivity between the conductive particle transfer layer (880 ohms/cm) and the transferred conductive lines (5.7 ohms) was largely the result of fusing or sintering of the conductive particles by first the application of the transfer heat energy and secondly the fusing heat applied by the second resistive thermal head. Prior art conductive ink systems rely on a higher loading of conductive particles to obtain equivalent resistivity resulting in high costs and less flexibility of the conductive pattern. The fusing of the conductive particles during heated transfer allowed for less usage of the expensive conductive particles to be utilized and as a result, the utilization of more extensible polymer matrix which increases flexure durability.

Further, the unused thermal print heads in the Kodak ML500 printer could have been used to apply a blanket polymer to further protect the conductive printed areas from environmental issues such as scratching, abrasion, water, or oxidation of the silver flake. In addition, the use of subsequent thermal print heads or a heated roller could have been utilized to further reduce the resistivity of the conductive pattern by further sintering the conductive particles contained in the conductive pattern.

While this example was directed at the use of resistive head thermal printed conductive lines, this invention can be used to form EMI shields, conductive traces utilized in membrane switches, conductive back planes for LCD TFT arrays, diffusely reflective optical elements, electrical connections, antistatic patterns for sensitive electrical components, electrical fuses and resistive heating elements.

The invention has been described in detail with particular reference to certain preferred embodiments thereof, but it will be understood that variations and modifications can be effected within the spirit and scope of the invention.

1. A transfer element comprising a base having thereon a transfer layer of inorganic conductive particles in a polymer matrix wherein said transfer layer of inorganic conductive particles has an adhesion to said base of between 20 and 400 grams/cm.

2. The transfer element of claim 1 wherein said inorganic conductive particles have at least one dimension of less than 100 nanometers.

3. The transfer element of claim 1 wherein said inorganic conductive particles have an aspect ratio of at least 1000:1.

4. The transfer element of claim 1 wherein said inorganic conductive particles comprise metallic flake having a thickness between 0.2 and 2 micrometers.

5. The transfer element of claim 1 wherein said polymer matrix comprises an electrically conductive polymer.

6. The transfer element of claim 1 wherein said inorganic conductive particles comprise a metal selected from at least one member of the group consisting of copper, aluminum, gold, iron, platinum, silver, nickel, magnesium and lithium.

7. The transfer element of claim 1 wherein said inorganic conductive particles comprise silver.

8. The transfer element of claim 1 wherein said inorganic conductive particles comprise whisker shaped particles.

9. The transfer element of claim 1 wherein said inorganic conductive particles comprise platelets.

10. The transfer element of claim 1 wherein said transfer layer has a resistivity of greater than 1.0×10² ohms/cm.

11. The transfer element of claim 1 wherein said transfer layer has a matrix polymer comprising polyurethane.

12. The transfer element of claim 1 wherein said transfer layer has a matrix polymer has a Tg of between 30 and 80° C.

13. The transfer element of claim 1 wherein the average spacing between said conductive particles is between 20 and 600 nanometers.

14. The transfer element of claim 1 wherein said transfer layer comprises colorants.

15. The transfer element of claim 1 wherein said base has a surface energy of between 28 and 36 dynes/cm² on the side adjacent to said transfer layer.

16. The transfer element of claim 1 wherein said transfer layer can have two or more layers that differ in conductivity and/or composition.

17. The transfer element of claim 1 wherein said base further comprises a thermally-activated release layer.

18. The transfer element of claim 1 wherein said transfer layer further comprises a surfactant.

19. An electrically patterned element comprising a flexible substrate and a receiving layer wherein said receiving layer is provided with a conductive pattern having a resistivity of less than 10 ohms/cm, and wherein said conductive pattern comprises inorganic conductive particles in a matrix polymer.

20. An electrically patterned element of claim 19 wherein said inorganic conductive particles are in sufficient close contact such that the resistivity is less than 10 ohms/cm.

21. The electrically patterned element of claim 19 wherein said receiving layer comprises a pattern of adhesive transfer sites.

22. The electrically patterned element of claim 19 further comprising a blanket polymer layer.

23. The electrically patterned element of claim 22 further comprising at least one further conductive pattern on said blanket layer.

24. The electrically patterned element of claim 23 further comprising at least one conductive hole through said blanket layer to connect the first conductive pattern and said at least one further conductor.

25. The electrically patterned element of claim 19 wherein said conductive pattern comprises lines having a width of between 5 and 50 microns.

26. The electrically patterned element of claim 25 wherein said lines have a line edge wiggle factor of less than 10%.

27. A diffusely reflective patterned element comprising a flexible substrate having on at least one surface polymeric protuberances having an average height greater than 10 micrometers and a layer of diffusely reflective particles located on a top surface of said protuberances wherein said top surface has a diffuse reflectivity of at least 80%.

28. The diffusely reflective patterned element of claim 27 wherein said protuberances have an average height between 10 and 100 micrometers

29. The diffusely reflective patterned element of claim 27 wherein said diffusely reflective particles are selected from at least one member of the group consisting of Cu, Ag Au, Al, Ni, TiO₂ and BaSO₄

30. The diffusely reflective patterned element of claim 27 wherein said protuberances comprise prism elements.

31. The diffusely reflective patterned element of claim 27 wherein said flexible substrate has a diffusely reflective particles covering between 1 to 50% of the surface area of said flexible substrate.

32. A method of forming a patterned element comprising providing a transfer element comprising a base having thereon a transfer layer of inorganic conductive particles in an insulating polymer matrix wherein said transfer layer of inorganic conductive particles has an adhesion to said base of between 20 and 400 grams/cm, bringing said transfer element into transferring contact with a receiver element, wherein said receiver element comprises a flexible substrate and a receiver layer, transferring said transfer layer to said receiving element in a pattern.

33. The method of claim 32 wherein said transferring of the transfer element to the receiving element is a heated transfer.

34. The method of claim 32 wherein the Tg of said receiver layer is less than the Tg of said polymer matrix.

35. The method of claim 32 further comprising applying heat to said patterned element after the transfer element has been transferred to said receiving element in a pattern.

36. The method of claim 32 further comprising applying a blanket polymer on the surface of said patterned conductive element.

37. The method of claim 32 wherein said receiving element comprises a hot melt adhesive having a Tg greater than 30 degrees C.
